(19) United States
(12) Patent Application Publication
(10) Pub. No.: US 2024/0255233 A1
(43) Pub. Date: Aug. 1, 2024

(54) HEAT EXCHANGER, POWER CONVERSION DEVICE INCLUDING HEAT EXCHANGER, AND METHOD FOR MANUFACTURING INNER FIN FOR HEAT EXCHANGER

(71) Applicant: HITACHI ASTEMO, LTD., Hitachinaka-shi, Ibaraki (JP)

(72) Inventors: Yusuke TAKAGI, Hitachinaka-shi (JP); Yujiro KANEKO, Hitachinaka-shi (JP)

(73) Assignee: HITACHI ASTEMO, LTD., Hitachinaka-shi, Ibaraki (JP)

(21) Appl. No.: 18/564,148

(22) PCT Filed: Jul. 21, 2021
(86) PCT No.: PCT/JP2021/027394

§ 371 Date: Nov. 27, 2023

(51) Int. Cl. F28F 1/40; F28F 3/02; F28F 3/12; H02M 7/00

(52) U.S. Cl. CPC F28F 1/40; F28F 3/025; F28F 3/12; H02M 7/003

(57) ABSTRACT

In a heat exchanger, an inner fin having heat transference is disposed in a flat passage, the inner fin is formed by a plurality of fin portions having a convex shape formed by a top surface portion and a side surface portion and having a hollow inside the convex shape; when a direction in which the plurality of fin portions are formed and lined to be continuous via a coupling portion is defined as a first direction and a direction in which slits are formed between the plurality of fin portions and lined is defined as a second direction, the plurality of fin portions are arranged at a predetermined interval in the second direction; and the inner fin is arranged such that the first direction and the second direction respectively forms an acute angle with respect to a flow of a refrigerant flowing in the flat passage.

### TECHNICAL FIELD

The present invention relates to a heat exchanger, a power conversion device including the heat exchanger, and a method for manufacturing an inner fin for a heat exchanger.

### BACKGROUND ART

As a background art of the invention of the present application, the following PTL 1 describes a heat exchanger having a fin shape in which a planar portion is arranged in parallel with a flow of cooling water in order to reduce a pressure loss of a passage without deteriorating heat exchanging performance.

### CITATION LIST

### Patent Literature

PTL 1: JP 2018-169073 A

### SUMMARY OF INVENTION

### Technical Problem

In order to further improve the performance of the fin in view of the technique of PTL 1, the present invention aims to provide a heat exchanger with improved heat radiation performance, a power conversion device including the heat exchanger, and a method for manufacturing an inner fin for the heat exchanger.

### Solution to Problem

In a heat exchanger including an inner fin having heat transference and disposed in a flat passage, and a power conversion device including the heat exchanger, the inner fin is formed by a plurality of fin portions having a convex shape formed by a top surface portion and a side surface portion and having a hollow inside the convex shape; when a direction in which the plurality of fin portions are formed and lined to be continuous via a coupling portion is defined as a first direction and a direction in which slits are formed between the plurality of fin portions and lined is defined as a second direction, the plurality of fin portions are arranged at a predetermined interval in the second direction; and the inner fin is arranged such that the first direction and the second direction respectively forms an acute angle with respect to a flow of a refrigerant flowing in the flat passage.

A method for manufacturing an inner fin for a heat exchanger disposed in a flat passage of the heat exchanger and having heat transference includes a first step of performing rectangular punching at a predetermined interval along a side of a plate material having heat conductivity; a second step of performing bending with respect to a longitudinal direction of the plate material to form a plurality of fin portions; a third step of cutting the plate material in an oblique direction with respect to the side so as to be accommodated in the flat passage; and a fourth step of removing a plurality of incomplete fin portions produced by the cutting in the third step.

### Advantageous Effects of Invention

A heat exchanger with improved heat radiation performance, a power conversion device including the heat exchanger, and a method for manufacturing an inner fin for a heat exchanger can be provided.

### BRIEF DESCRIPTION OF DRAWINGS

FIG. 1 is a block diagram of an entire power conversion device.

FIG. 2 is a circuit diagram of a molded body of the power conversion device.

FIG. 3 is an external view of the molded body of FIG. 1.

FIG. 4 is a cross-sectional view taken along line A-A of the molded body of FIG. 2.

FIG. 5 is an exploded view of a power module including the heat exchanger of the present invention.

FIG. 6 is an exploded view of a first water channel of FIG. 4.

FIG. 7 is an exploded view of a second water channel of FIG. 4.

FIG. 8 is a structural diagram of a cooling water channel according to the first embodiment of the present invention.

FIG. 9 is a schematic flow diagram of the cooling water in the cooling water channel according to the first embodiment of the present invention.

FIG. 10 is a cross-sectional view taken along line D-D of FIG. 7.

FIG. 11 is a structural diagram of a cooling water channel according to a second embodiment of the present invention.

FIG. 12 is a fin manufacturing process of the present invention.

Hereinafter, embodiments of the present invention will be described with reference to the drawings. The following description and drawings are examples for describing the present invention, and are omitted and simplified as appropriate for the sake of clarity of description. The present invention can be implemented in various other forms. Unless otherwise specified, each component may be singular or plural.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the position, size, shape, range, and the like disclosed in the drawings.

### FIRST EMBODIMENT AND OVERALL CONFIGURATION

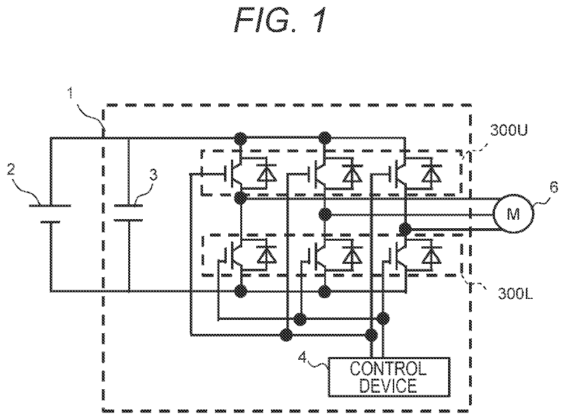

FIG. 1 is a block diagram of an entire power conversion device.

A power conversion device 1 is a device for converting direct current from a direct current (DC) power supply (battery) 2 into alternating current (AC) and outputting the alternating current to a motor 6. The power conversion device 1 includes a capacitor 3, a control device 4, an upper arm 300U, and a lower arm 300L. The capacitor 3 smooths the DC power output from the DC power supply 2. The control device 4 controls switching operations of the upper arm 300U and the lower arm 300L, which are switching elements.

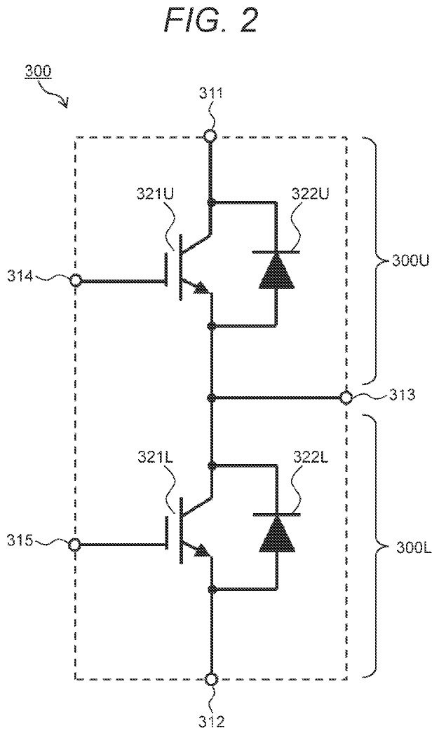

FIG. 2 is a circuit diagram of a molded body of the power conversion device.

A molded body 300 having a function of a power module includes power semiconductor elements 321, 321L, 322U, and 322L. The power semiconductor elements 321U and 321L are insulated gate bipolar transistors (IGBTs). The power semiconductor elements 322U and 322L are diodes. The power semiconductor elements 321U, 321L, 322U, and 322L can be alternatively applied with a field effect transistor (FET) or the like.

The molded body 300 is configured by an upper arm 300U and a lower arm 300L. The upper arm 300U is configured by an IGBT 321U and a diode 322U. The lower arm 300L is configured by an IGBT 321L and a diode 322L. The upper arm 300U has a DC positive electrode terminal 311 and a signal terminal 314. The lower arm 300L has a DC negative electrode terminal 312 and a signal terminal 315.

The DC positive electrode terminal 311 and the DC negative electrode terminal 312 are connected to the capacitor 3 and the like, and supply power from the outside of the molded body 300. The signal terminals 314 and 315 are connected to a control substrate including the control device 4, and control switching operation of the power semiconductor element. The molded body 300 includes an AC terminal 313. The AC terminal 313 electrically connects the upper arm 300U and the lower arm 300L, and outputs an AC current to the outside of the molded body 300.

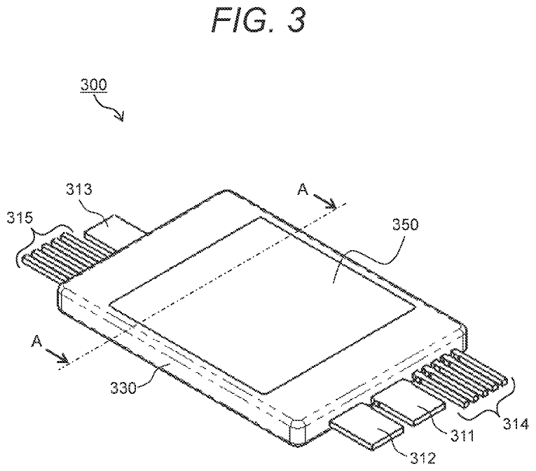

FIG. 3 is an external view of the molded body of FIG. 1.

The molded body 300 is sealed with a sealing resin 330. The DC positive electrode terminal 311 is exposed from the sealing resin 330. The DC negative electrode terminal 312 is exposed from the sealing resin 330. The AC terminal 313 is exposed from the sealing resin 330. The signal terminals 314 and 315 are exposed from the sealing resin 330. The molded body 300 includes a heat conduction member 350.

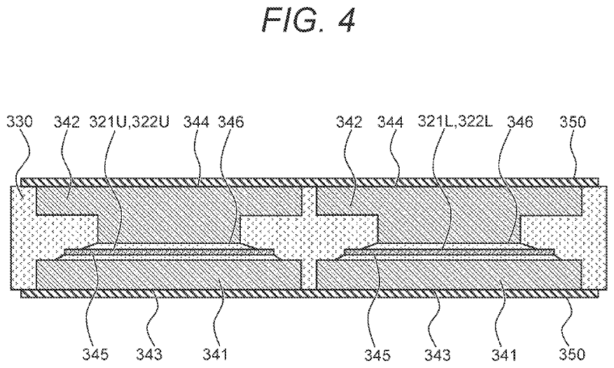

FIG. 4 is a cross-sectional view taken along line A-A of the molded body in FIG. 3.

Main surfaces of the semiconductor elements 321U, 321L, 322U, 322L are bonded to the first heat radiation plate 341 by way of a first bonding material 345. The semiconductor elements 321U, 321L, 322U, 322L have the main surface and the surface on the opposite side bonded to the second heat radiation plate 342 by way of a second bonding material 346.

The first bonding material 345 and the second bonding material 346 are solder, a sintered material, or the like. The first heat radiation plate 341 and the second heat radiation plate 342 are an insulating substrate made of metal such as copper and aluminum, or having a copper wiring, or the like.

The sealing resin 330 seals the semiconductor elements 321U, 321L, 322U, and 322L, the first heat radiation plate 341, the second heat radiation plate 342, the first bonding material 345, and the second bonding material 346. The first heat radiation plate 341 has a first heat radiation surface 343. The first heat radiation surface 343 is located on a surface of the first heat radiation plate 341 opposite to a surface bonded to the first bonding material 345. The first heat radiation surface 343 is exposed from the sealing resin 330.

The second heat radiation plate 342 has a second heat radiation surface 344. The second heat radiation surface 344 is located on a surface of the second heat radiation plate 342 opposite to a surface bonded to the second bonding material 346. The second heat radiation surface 344 is exposed from the sealing resin 330. The two heat conduction members 350 are in close contact with the first heat radiation surface 342 and the second heat radiation surface 344, respectively.

The heat conduction member 350 is made of resin or ceramic having insulating property. In a case where the heat conduction member 350 is made of ceramic, the heat conduction member is brought into close contact with the molded body 300 and a first water channel 110 and a second water channel 210, described later, via grease or the like. The heat conduction member 350 is grease when an insulating board or a resin insulating member is provided inside the molded body 300.

The molded body 300 is a heat generating body that generates heat when a current flows through each of the semiconductor elements 321U, 321L, 322U, and 322L. The molded body 300 is cooled by releasing heat to the refrigerant in each of the water channels through the heat conduction member 350, the first water channel 110 and the second water channel 210 described later.

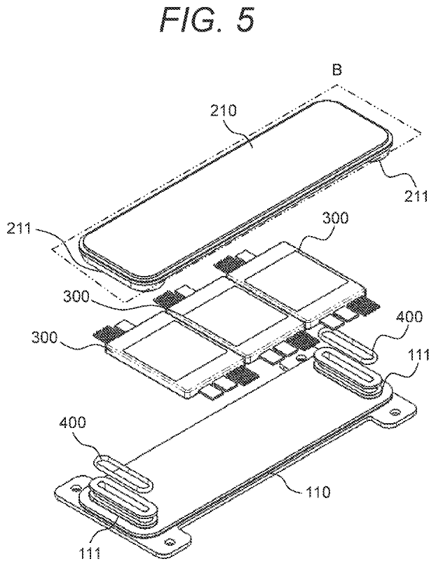

FIG. 5 is an exploded view of a power module including the heat exchanger of the present invention.

The molded body 300 is disposed so as to be sandwiched between the first water channel 110 and the second water channel 210 which are heat exchangers. The first water channel 110 has a first water channel connecting portion 111. The second water channel 210 has a second water channel connecting portion 211. The first water channel connecting portion 111 is connected to the second water channel connecting portion 211 so as to form a water channel. A connecting portion between the first water channel connecting portion 111 and the second water channel connecting portion 211 is sealed with a seal material 400.

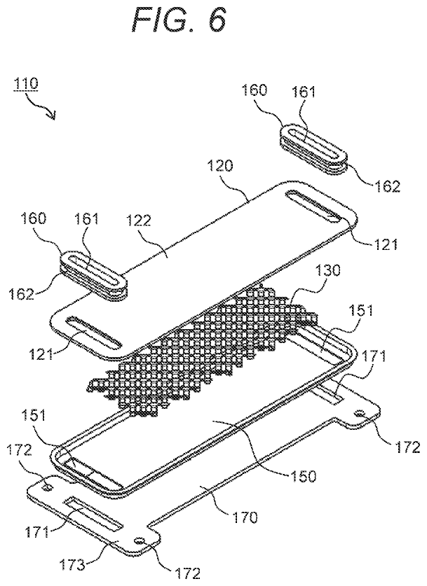

FIG. 6 is an exploded view of the first water channel of FIG. 5.

The first water channel 110 includes a first water channel base 120, a first fin 130, a first water channel cover 150, a first pipe 160, and a water channel connecting flange 170. The water channel connecting flange 170 has a water channel attachment surface 173. The water channel attachment surface 173 is connected to a case or the like for supplying cooling water from the outside.

The water channel connecting flange 170 has a water channel attachment hole 172. The water channel attachment hole 172 is a screw hole for fixing to a case or the like for supplying cooling water from the outside. Note that, in the case of fixing to the case other than by screw fastening, the water channel attachment hole 172 is unnecessary. The water channel connecting flange 170 has a water channel opening 171. The water channel opening 171 is an inlet or an outlet of the cooling water.

The first water channel cover 150 has two first water channel cover openings 151 at both ends in the longitudinal direction. The first water channel cover opening 151 is connected to the water channel opening 171, and the cooling water flows therethrough. The first water channel base 120 has two first water channel base openings 121 at both ends in the longitudinal direction.

Two first pipes 160 are disposed at both ends of the first water channel 110. The first pipe 160 has a first pipe opening 161. The first pipe 160 is connected to the first water channel base opening 121 to form a water channel. The first pipe 160 has a seal material accommodating portion 162. The seal material accommodating portion 162 is a region that accommodates the seal material 400.

The first water channel base 120 has a first water channel base heat radiation surface 122. The first water channel base heat radiation surface 122 is in close contact with the molded body 300 to contribute to cooling of the molded body 300. The first fin 130, which is an inner fin having heat transference, is bonded to the first water channel base 120 on the opposite side of the first water channel base heat radiation surface 122.

The first fin 130 is bonded to the first water channel cover 150. The first water channel cover 150 is bonded to the water channel connecting flange 170. This bonding portion is bonded by brazing or laser welding.

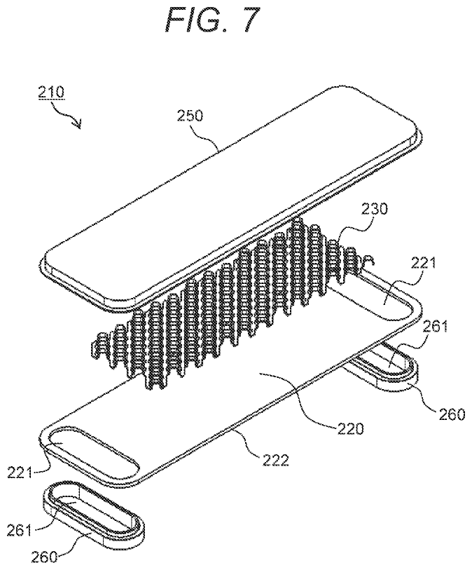

FIG. 7 is an exploded view of the second water channel of FIG. 5.

The second water channel 210 includes a second water channel base 220, a second fin 230, a second water channel cover 250, and a second pipe 260. The second water channel base 220 has two second water channel base openings 221 at both ends in the longitudinal direction.

The second water channel base opening 221 at one end causes cooling water to flow to one end of the second fin 230. The second water channel base opening 221 at the other end causes cooling water to flow to the other end of the second fin 230.

Two second pipes 260 are disposed at both ends of the second water channel 210. The second pipe 260 has a second pipe opening 261. The second pipe 260 is connected to the second water channel base opening 221 to form a water channel.

The second water channel base 220 has a second water channel base heat radiation surface 222. The second fin cover heat radiation surface 221 is in close contact with the molded body 300 to cool the molded body 300. The second water channel base 220 has a second water channel base heat radiation surface 222 for cooling the molded body 300. The second fin 230 is bonded to the second water channel base 220 on the surface opposite to the second water channel base heat radiation surface 222.

The second fin 230 cools the molded body 300 through the second water channel base heat radiation surface 222. The second fin 230 is bonded to the second water channel cover 250. This bonding is performed by brazing or laser welding similarly to the first water channel 110.

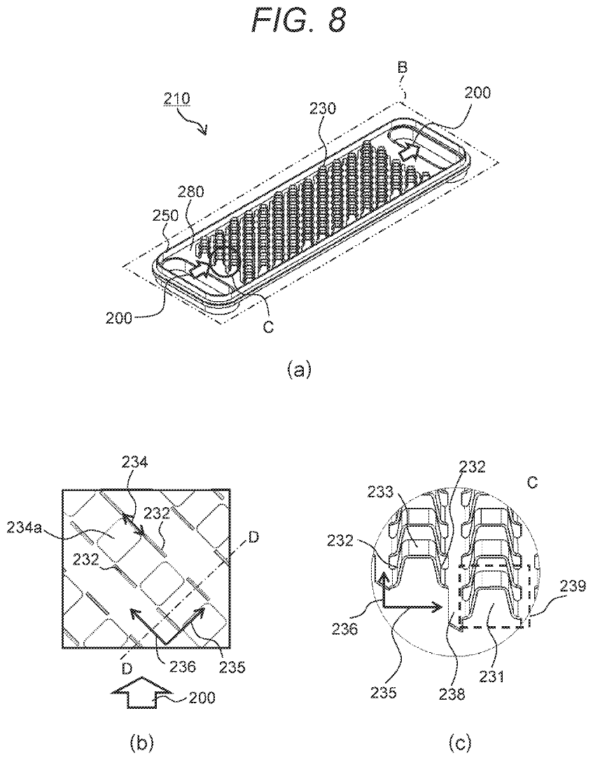

FIG. 8 is a structural diagram of a cooling water channel according to the first embodiment of the present invention.

FIG. 8(a) is obtained by removing the cover 250 from the second water channel 210 of FIG. 5. FIG. 8(b) is a plan view of a cross section B (a position where the bonding surface between the second water channel cover 250 and the second fin 230 is cut). FIG. 8(c) is an enlarged view of a portion C in FIG. 8(a).

Since the same applies to the first water channel 110 and the first fin 130, only the description of the second water channel 210 and the second fin 230 will be given, and the description of the configurations of the first water channel 110 and the first fin 130 will be omitted.

The second water channel 210 forms a fin flow path 280. The fin flow path 280 is formed such that the cooling water 200 passes through the second fin 230. The second fin 230 has a plurality of fin portions 239 and a fin coupling portion 238. In the fin portion 239, two fin side surface portions 232 and a fin top surface portion 233 form a hollow convex shape 231. The hollow convex shape 231 is a structure in which the cooling water 200 flows to the hollow portion.

The fin portion 239 is arranged obliquely with respect to the direction in which the cooling water 200 flows (the longitudinal direction of the flow path 280), and the next fin portion 239 is formed at the same inclination with an interval 234 provided on the extension thereof. A slit 234a is provided between the obliquely arranged fin portions 239.

The fin top surface portion 233 is bonded to the second water channel cover 250. A plurality of fin portions 239 are formed in a row along a first direction 235 via the coupling portion 238. In addition, the fin portions 239 are repeatedly arranged to form a fin row along a second direction 236 in which slits 234a are formed and arranged between the plurality of fin portions 239, the second direction being a direction different from the first direction 235. Note that a right angle is defined between the first direction 235 and the second direction 236.

In this fin row, a predetermined fin interval 234 is provided between the fin portions 239 as described above, and the slit 234a is formed in a portion of the predetermined interval 234. This is a portion where punching is performed on a sheet metal in a fin manufacturing process described later.

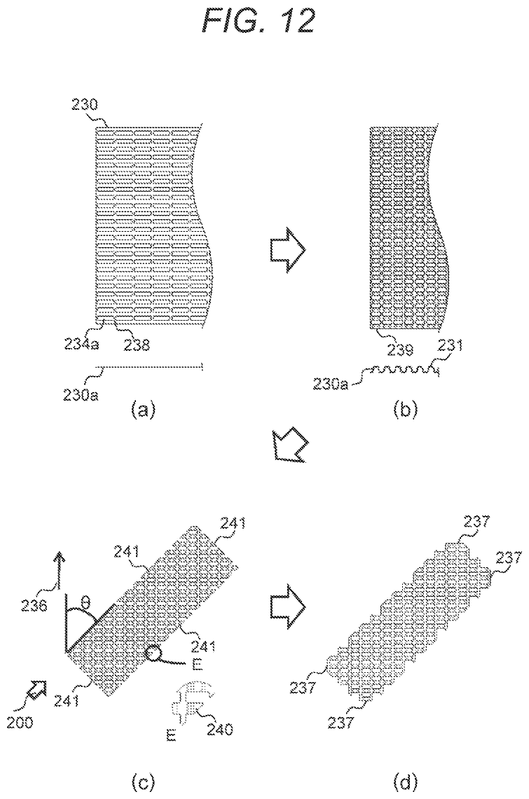

The plurality of fin portions 239 are connected to each other by the fin coupling portion 238. The fin 230 can be processed and formed from one plate by providing the fin coupling portion 238, and productivity can be improved. Note that a method for manufacturing the fin 230 will be described later with reference to FIG. 12. The fin side surface portion 232 is formed on a straight line parallel to the second direction 236. In this way, when the fin 230 is manufactured by machining using a sheet metal press or the like, mold can be simplified as the fi can be formed simply by being processed linearly, and hence productivity is improved.

Both the first direction 235 and the second direction 236 form an acute angle with respect to the cooling water flow direction 200. That is, the fin 230 has a structure of being inclined with respect to the flow of the cooling water 200. In this manner, the heat radiation performance can be improved by raising the flow speed in the vicinity of the wall surface portion of the fin 230.

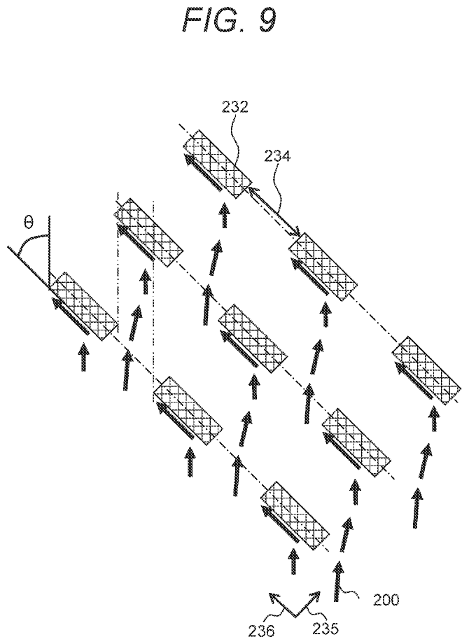

FIG. 9 is a schematic flow diagram of the cooling water in the cooling water channel according to the first embodiment of the present invention.

The size of the arrow of the cooling water 200 represents the flow speed, and the length of the arrow is illustrated so as to become longer as the speed becomes higher. The fins 230 are arranged to be inclined with respect to the flow of cooling water 200 such that the angle θ formed by the second direction 236 and the cooling water flow direction is larger than 0° and smaller than 90° (acute angle), and the cooling water 200 flowing through the fin interval 234 hits the fin side surface portion 232. In this way, the flow speed in the vicinity of the fin side surface portion 232 increases, and high cooling performance is obtained. In the verification result compared with the prior art in which the fin side surface portion 232 is parallel to the direction in which the cooling water 200 flows (the angle θ is 0°), it was found that, in the configuration of the present invention, the relative value of the heat transfer rate is improved by 60% as compared with the prior art according to the heat transfer analysis.

The angle θ formed by the second direction 236 and the cooling water flow direction is preferably from 15° to 75° from the viewpoint of improving the cooling performance. In the verification, it was found that the method for installing the fin 230 so that the angle of the fin is 60° with respect to the flow of the cooling water has the highest performance. Furthermore, although description has been made with a configuration in which the fin 230 is arranged inclined to the left in the drawing, the fin may be arranged inclined to the right.

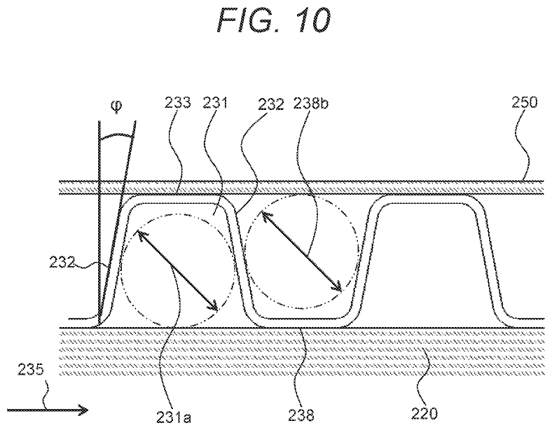

FIG. 10 is a cross-sectional view taken along line D-D of FIG. 8(b).

In the hollow convex shape 231, the inside is formed to a cavity so that dust (contamination) that has a possibility of being contained in the cooling water is not clogged, and the diameter 231a of the largest circle entering the inside is defined. Similarly, the diameter 238b of the largest circle entering between adjacent fin portions 239 through the coupling portion 238 in the first direction 235 is defined. At this time, the diameter 238b is greater than or equal to the diameter 231a. Although not illustrated in FIG. 10, the fin interval 234 is also greater than or equal to the diameter 231a. In this way, dust clogging can be prevented even on the fin interval 234 or the fin coupling portion 238.

It is also possible to further improve the cooling performance by unifying the diameter 231a, the diameter 238b, and the fin interval 234 to substantially the same size and increasing the number of fins as much as possible to increase the heat radiation surface. The angle φ formed by the thickness direction (up-down direction in the plane of drawing) of the second water channel base 220 and the fin side surface portion 232 is preferably greater than or equal to 0° in view of sheet metal press moldability.

### SECOND EMBODIMENT

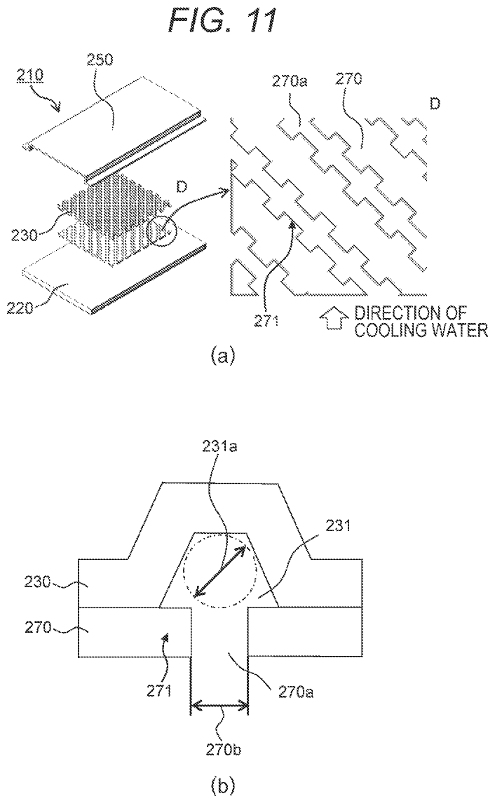

FIG. 11 is a structural diagram of a cooling water channel according to a second embodiment of the present invention.

In the flow path 210, a fin plate 270 (see an enlarged view D) is installed between the fin 230 and the flow path base 220. The fin plate 270 has a groove 270a, and protrusions 271 that face each other are formed on a side surface of the groove 270a. The groove 270a has a structure in which the protrusion 271 is formed in accordance with the hollow 231 portion of the fin 230 (see FIG. 11(b)), and thus has a structure in which the protrusion 271 overlaps the bottom portion of the hollow 231 portion. The width 270b between the protrusions 271 is smaller than the diameter 231a.

With such a configuration, a turbulent flow speed of the cooling water 200 can be locally increased to improve cooling performance, so that heat radiation performance can be improved. In addition, the heat radiation surface area can be increased by providing the fin plate 270. Furthermore, problems such as contamination clogging can also be solved. According to this configuration, a verification result was obtained that the heat transfer rate improved by 17% as compared with the configuration without the fin plate 270.

FIG. 12 is a diagram describing a fin manufacturing process of the present invention.

As a method for manufacturing the second fin 230, sheet metal press is preferable in consideration of productivity. The manufacturing process of the second fin 230 is divided into a punching process (a), a bending process (b), an outer shape trimming process 1(c), and an outer shape trimming process 2(d). Note that the outer shape trimming process 1 and the outer shape trimming process 2 may be performed simultaneously.

First, in the punching process, the second fin 230 is subjected to a rectangular punching process at predetermined intervals along the side of one plate material, thereby forming the fin interval 234 and the fin coupling portion 238 on the plate.

Next, in the bending process, the fin portion 239 is bent with respect to the longitudinal direction of the plate material to form a hollow convex shape 231 (see the fin plane viewpoint 230a in FIGS. 12(a) and 12(b)). The bending may be performed for each fin row or may be collectively performed.

Next, in the outer shape trimming process, cutting is performed in an oblique direction with respect to the plate material so as to be accommodated in the flat passage, in other words, punching is performed so that the fin outer shape 241 becomes an angle θ formed by the second direction 236 and the cooling water flow direction 200. At this time, an incomplete fin portion 240 in which the fin side surface portion 232 is not coupled with the fin coupling portion 238 is formed in the fin portion 239.

Finally, in the outer shape trimming process 2, the incomplete fin portion 240 produced in the previous process is removed by punching. Since there is a high possibility that the incomplete fin portion 240 is easily deformed in handling during transportation of a component and becomes a defective product, removal facilitates handling and improves productivity. After the outer shape trimming process 2, a fin positioning portion 237 is formed on the fin outer shape 241 and a shape to be accommodated in the flow path is obtained.

By adopting such a fin manufacturing method, a fin inclined with respect to the flow of cooling water can be made by using a simple process of bending in a right angle direction of the material, and the configuration of the present invention in which a plurality of fin portions 239 are repeatedly arranged in parallel in the second direction 236 and fin members are continuously formed can be realized.

According to the first and second embodiments of the present invention described above, the following operational effects are achieved.

(1) In a heat exchanger including an inner fin 130, 230 having heat transference and disposed in a flat passage, the inner fin 130, 230 is formed by a plurality of fin portions 239 having a convex shape 231 formed by a top surface portion 233 and a side surface portion 232 and having a hollow inside the convex shape 231, where when a direction in which the plurality of fin portions 239 are formed and lined to be continuous via a coupling portion 238 is defined as a first direction 235 and a direction in which slits 234a are formed between the plurality of fin portions 239 and lined is defined as a second direction 236, the plurality of fin portions 239 are arranged at a predetermined interval 234 in the second direction 236, and the inner fin 130, 230 is arranged such that the first direction 235 and the second direction 236 respectively forms an acute angle with respect to a flow of a refrigerant flowing in the flat passage. With this configuration, a heat exchanger with improved heat radiation performance can be provided.

(2) In the plurality of fin portions 239, when the diameter of the largest circle entering the hollow is defined as a first diameter 231a, and the diameter of the largest circle entering the coupling portion 238 connecting the respective side surface portions 232 of the adjacent fin portions 239 is defined as a second diameter 238b, the second diameter 238b has a size greater than or equal to the first diameter 231a. In this way, dust clogging can be prevented on the fin interval 234 or the fin coupling portion 238.

(3) In the flat passage, a fin plate 270 having a plurality of groove 270a is provided between the flat passage lower portion 220 and the inner fin 130, 230. With such a configuration, a turbulent flow speed of the cooling water 200 can be locally increased to improve cooling performance, so that heat radiation performance can be improved. In addition, the heat radiation surface area can be increased. Furthermore, contamination (dust) clogging can be prevented.

(4) The groove 270a of the fin plate 270 is formed with a plurality of protrusions 271, and a width 270b between the plurality of protrusions 271 facing each other is smaller than the first diameter 231a. With such a configuration, a turbulent flow speed of the cooling water 200 can be locally increased to improve cooling performance.

(5) The power conversion device 1 includes the heat exchanger of the present invention. Therefore, the present invention can be applied to a vehicle or the like on which the power conversion device 1 is mounted.

(6) A method for manufacturing the inner fin 130, 230 for a heat exchanger disposed in a flat passage of the heat exchanger and having heat transference includes a first step of performing rectangular punching at a predetermined interval along a side of a plate material having heat conductivity, a second step of performing bending with respect to a longitudinal direction of the plate material to form a plurality of fin portions 239, a third step of cutting the plate material in an oblique direction with respect to the side so as to be accommodated in the flat passage, and a fourth step of removing a plurality of incomplete fin portions 240 produced by the cutting in the third step. The heat exchanger of the present invention thus can be realized.

Note that the present invention is not limited to the above embodiments, and various modifications and other configurations can be combined within a scope not deviating from the gist of the present invention. In addition, the present invention is not limited to those including all the configurations described in the above embodiments, and also includes those in which a part of the configuration is deleted.

### REFERENCE SIGNS LIST

1 power conversion device
2 DC power supply (battery)
3 capacitor
4 control device
6 motor
110 first water channel
111 first water channel connecting portion
120 first water channel base
121 first water channel base opening
122 first water channel base heat radiation surface
130 first fin
150 first water channel cover
151 first water channel cover opening
160 first pipe
161 first pipe opening
162 seal material accommodating portion
170 water channel connecting flange
171 water channel opening
172 water channel attachment hole
173 water channel attachment surface
200 (flowing direction of) cooling water
210 second water channel
211 second water channel connecting portion
220 second water channel base
221 second water channel base opening
222 second water channel base heat radiation surface
230 second fin
230a fin plane viewpoint
231 hollow convex shape
231a diameter of hollow convex shape
232 fin side surface portion
233 fin top surface portion
234 fin interval
234a slit
235 first direction
236 second direction
237 fin positioning unit
238 fin coupling portion
238b diameter of fin coupling portion
239 fin portion
240 incomplete fin portion
241 fin outer shape
250 second water channel cover
260 second pipe
270 fin plate
270a groove
270b width between fin plate protrusions
271 fin plate protrusion
271a fin plate gap
280 fin flow path
300 molded body
400 seal material

1. A heat exchanger comprising an inner fin having heat transference and disposed in a flat passage,
wherein
the inner fin is formed by a plurality of fin portions having a convex shape formed by a top surface portion and a side surface portion and having a hollow inside the convex shape;
when a direction in which the plurality of fin portions are formed and lined to be continuous via a coupling portion is defined as a first direction and a direction in which slits are formed between the plurality of fin portions and lined is defined as a second direction, the plurality of fin portions are arranged at a predetermined interval in the second direction; and
the inner fin is arranged such that the first direction and the second direction respectively forms an acute angle with respect to a flow of a refrigerant flowing in the flat passage.

2. The heat exchanger according to claim 1, wherein in the plurality of fin portions, when a diameter of a largest circle entering the hollow is defined as a first diameter, and a diameter of a largest circle entering a coupling portion connecting the respective side surface portions of the adjacent fin portions is defined as a second diameter, the second diameter has a size greater than or equal to the first diameter.

3. The heat exchanger according to claim 2, wherein in the flat passage, a fin plate including a plurality of grooves is provided between a flat passage lower portion and the inner fin.

4. The heat exchanger according to claim 3, wherein
the groove is formed with a plurality of protrusions; and
a width between the plurality of protrusions facing each other is smaller than the first diameter.

5. A power conversion device comprising the heat exchanger according to claim 1.

6. A method for manufacturing an inner fin disposed in a flat passage of a heat exchanger and having heat transference, the method comprising:
a first step of performing rectangular punching at a predetermined interval along a side of a plate material having heat conductivity;
a second step of performing bending with respect to a longitudinal direction of the plate material to form a plurality of fin portions;
a third step of cutting the plate material in an oblique direction with respect to the side so as to be accommodated in the flat passage; and
a fourth step of removing a plurality of incomplete fin portions produced by the cutting in the third step.
